(19) United States
(12) Patent Application Publication
(10) Pub. No.: US 2018/0374588 A1
(43) Pub. Date: Dec. 27, 2018

(54) METHOD AND APPARATUS FOR PRODUCING RADIOISOTOPES USING FRACTIONAL DISTILLATION

(71) Applicant: Muons, Inc., Batavia, IL (US)

(72) Inventor: Rolland Paul Johnson, Newport News, VA (US)

(21) Appl. No.: 16/010,147

(22) Filed: Jun. 15, 2018

Related U.S. Application Data
(60) Provisional application No. 62/520,778, filed on Jun. 16, 2017.

(51) Int. Cl. G21C 1/02; G21C 5/20

(52) U.S. Cl. CPC G21C 1/02; G21C 5/20

(57) ABSTRACT

An example of a system for producing and collecting one or more radioisotopes includes one or more fractional distillation columns that can receive a mixture and produce one or more radioisotopes using the mixture by fractional distillation. In various embodiments, a molten-salt nuclear reactor produces the mixture including one or more fission products. In various embodiments, the mixture includes helium gas carrying the one or more fission products, and the one or more radioisotopes include tritium.

### CLAIM OF PRIORITY

This application claims the benefit of priority under 35 U.S.C. § 119(e) of U.S. Provisional Patent Application Ser. No. 62/520,778, filed on Jun. 16, 2017, which is herein incorporated by reference in its entirety.

### TECHNICAL FIELD

This document relates generally to radioisotope production and more particularly to a system for producing tritium and/or other radioisotopes using fractional distillation.

### BACKGROUND

By-products of nuclear power generation and other applications of nuclear fission include radioactive fission products that can be hazardous to health and environment. On the other hand, such radioactive fission products may contain valuable radioisotopes. One example is tritium, a radioisotope of hydrogen that can be used in fuels for nuclear fusion reactions and found in nuclear fission products. Tritium also has other applications such as being used as a radioactive tracer, in radio luminescent light sources for watches and instruments, and for long-living (e.g., 100 years), low-power (e.g., 100 We) energy sources.

### SUMMARY

An example of a system for producing and collecting one or more radioisotopes includes one or more fractional distillation columns that can receive a mixture and produce one or more radioisotopes using the mixture by fractional distillation. In various embodiments, a molten-salt nuclear reactor produces the mixture including one or more fission products.

In one example, a system for producing and collecting tritium can include a fractional distillation column configured to receive a mixture including helium gas and to produce one or more radioisotopes by separating the one or more radioisotopes from the mixture using fractional distillation. The fractional distillation column can include one or more condensers each configured and positioned to collect a radioisotope of the one or more radioisotopes. The one or more condensers can include a condenser configured and positioned to collect tritium.

In another example, a method for producing and collecting tritium is provided. A mixture including helium gas is received. One or more radioisotopes can be produced by separating the one or more radioisotopes from the mixture using fractional distillation. The one or more radioisotopes can include tritium.

This summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 illustrates an embodiment of a power generation system based on a molten-salt nuclear reactor.

FIG. 2 illustrates an embodiment of energy and fission products produced by operating the nuclear reactor of FIG. 1.

FIG. 3 illustrates an embodiment of a fraction distillation column for collecting radioisotopes from fission products, such as the fission products produced by operating the nuclear reactor of FIG. 1.

FIG. 4 illustrates an embodiment of a system including a nuclear reactor and a fraction distillation system for collecting radioisotopes from fission products produced by the nuclear reactor.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

This document discusses, among other things, a system for producing tritium and/or other radioisotopes using fractional distillation. In various embodiments, the tritium and/or other radioisotopes are collected from fission products produced by a molten-salt reactor such as a Molten-Salt Reactor Experiment (MSRE). The MSRE was an experimental nuclear reactor constructed and operated at the Oak Ridge National Laboratory (ORNL) for research during the 1960's. Recent resurgence of molten-salt-fueled nuclear reactor designs allows for application of the present subject matter in practice to produce and collect radioisotopes. Compared to traditional light water reactors, new molten-salt designs operate at higher temperature and allow access to fission products by means of helium flow over or though the core of an operating reactor without the constraint of cladded solid fuel. In various embodiments, the helium picks up the volatile radioisotopes and carries them to a hot cell facility where fractional distillation is used to separate and collect each radioisotope according to its boiling point (equivalent to condensation temperature), thereby purifying the helium gas before it is recirculated though the reactor.

An example of the present system uses GEM*STAR (Green Energy Multiplier*Subcritical Technology for Alternative Reactors) as the nuclear reactor. GEM*STAR is an application of accelerator technology in nuclear power generation, developed by Muons Incorporated (Batavia, Ill. U.S.A.) in partnership with Accelerator Driven Neutron Applications (ADNA) Corporation. GEM*STAR is discussed, for example, in Charles G. Bowman et al., “GEM*STAR: The Alternative Reactor Technology Comprising Graphite, Molten Salt. and Accelerators”, in Dan Gabriel Cacuci (ed.), Handbook of Nuclear Engineering, pp. 2841-2894, Springer Science+Business Media LLC 2010. While GEM*STAR is discussed as a specific example of the nuclear reactor whose fission products can be used to produce tritium and/or other radioisotopes using fractional distillation, the present subject matter is not limited to any particular type of nuclear reactor or fission product, but can be applied to collect various valuable radioisotopes from mixtures containing such radioisotopes.

GEM*STAR is an accelerator-driven molten-salt-fueled graphite-moderated thermal-spectrum reactor that can operate with different fissile fuels and uses a LiF—BeF₂ molten eutectic carrier salt. In one example, the natural ⁶Li abundance ratio of 7% in the LiF carrier is used to produce more than 2 kg/year of tritium using a 2.5 MW_{b} superconducting proton linac to drive the subcritical 500 MWₜ reactor burning surplus plutonium. The high operating temperature of the reactor and the continuous removal of the tritium from the reactor result in low partial pressure to minimize escape and embrittlement issues. The collection of valuable fission-product radioisotopes like Xenon-133 and Iodine-131 can also benefit from the high temperature and continuous removal and separation afforded by fractional distillation.

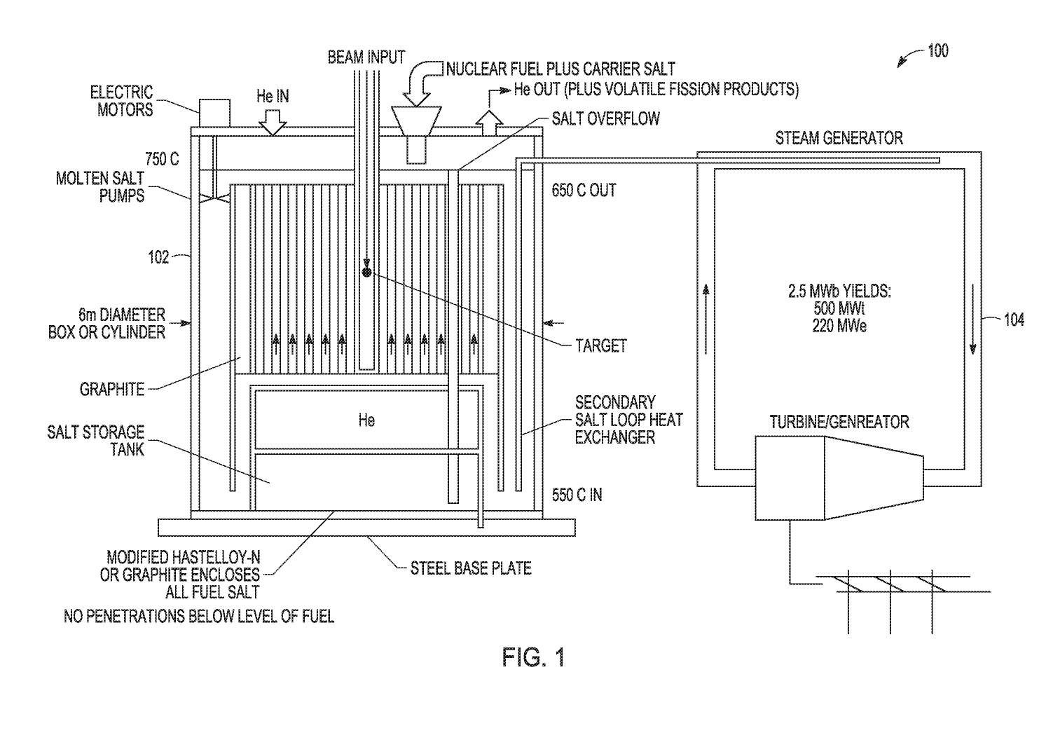

FIG. 1 illustrates an embodiment of an embodiment of a power generation system 100 that includes a molten-salt nuclear reactor 102 and an electric power generator 104. In the illustrated embodiment, nuclear reactor 102 is the GEM*STAR, which is an accelerator-driven molten-salt-fueled subcritical graphite-moderated nuclear reactor configured for generating electricity. The beam energy and power shown in the FIG. 1 correspond to burning PuF₃ in a eutectic LiF and BeF₂ carrier salt. One of the features of the GEM*STAR design is that volatile radioactive isotopes are continuously removed from the reactor by passing a flow of helium (He) through it.

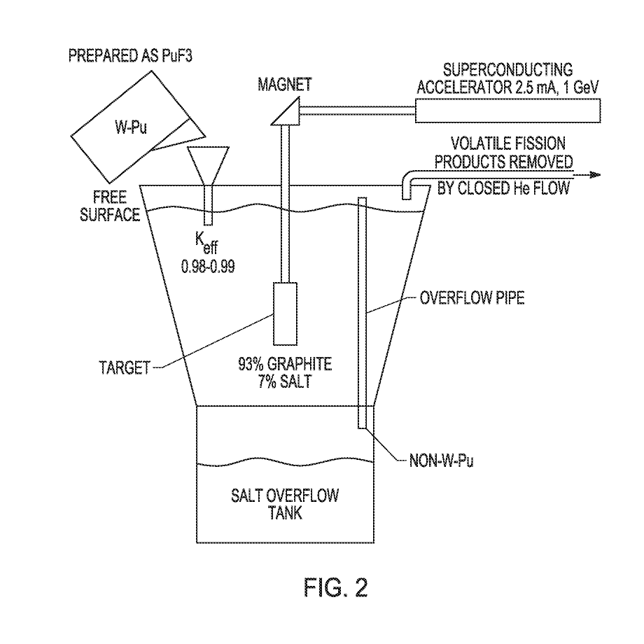

FIG. 2 illustrates an embodiment of energy and fission products produced by operating GEM*STAR as nuclear reactor 102 burning weapons-grade plutonium (W-Pu, composed of 93% ²³⁹Pu and 7% ²⁴⁰Pu). The isotopic abundance of Li-6 in the LiF—BeF eutectic is assumed to be negligible. Four GEM*STAR units, each producing 500 MWt of fission power, can burn 34 tons of W-Pu in 30 years. The hourly fuel fill includes 30 grams of W-Pu as PuF₃ plus carrier salt. This inflow of W-Pu includes 93% of ²³⁹Pu and 7% of ²⁴⁰Pu. The hourly overflow though the overflow pipe includes 7.5 grams of W-Pu as PuF₃, carrier salt, and 22.5 grams of fission product. This outflow of plutonium is a non-weapons-grade plutonium (Non-W-Pu, composed of 52.4% ²³⁹Pu, 25.4% ²⁴⁰Pu, 10.6% ²⁴¹Pu. and 11.7% ²⁴²Pu). The GEM*STAR units can produce 42 billion gallons of diesel in 30 years and about 10 kilograms of tritium per year. The W-Pu is transformed to permanent Non-W-Pu immediately upon adding to and mixing in the GEM*STAR units.

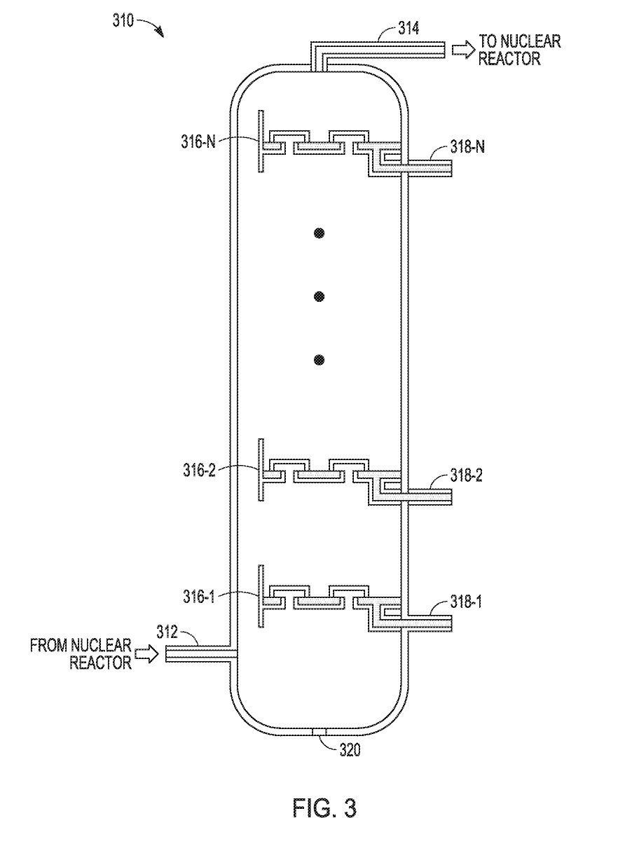

FIG. 3 illustrates an embodiment of a fraction distillation column 310 for collecting radioisotopes from fission products, such as the fission products generated by nuclear reactor 102. Fractional distillation is a technique for separating a mixture into its components by distillation. The mixture is heated to temperatures above each one or more of its compounds vaporize, thus allowing the components to be separated by their boiling points. One example is separation of components of crude oil using fractional distillation. Fractional distillation differs from distillation in that it separates a mixture into different parts called fractions. Fractional distillation is performed, for example, using a tall column including a plurality of condensers at different heights and the mixture placed at the bottom. Temperature in the columns decreases as the height increases from the bottom. Substances condense in condensers at different heights (temperature) according to their boiling points. In various embodiments, the volatile radioisotopes to be fractionally distilled are carried in a flow of helium gas such that the orientation of the orientation of the distillation columns may be vertical, horizontal, or any angle consistent with hot cell designs.

As illustrated in FIG. 3, fraction distillation column 310 can include a mixture input 312, a gas output 314, one or more condensers 316-1 to 316-N, one or more corresponding isotope outputs 318-1 to 318-N, and a residue output 320. Depending on the number of isotopies to be collected, N is an integer that is greater than or equal to 1.

Mixture input 312 can receive a mixture containing the mixture from which one or more radioisotopes are collected. When being heated, the mixture at the beginning of fractional distillation column 310 (the bottom as illustrated in FIG. 3) is evaporated and its vapors condense at different temperatures in the column. In the case of crude oil, each fraction contains hydrocarbon molecules with a similar number of carbon atoms. In various embodiments of the present system, the radioisotopes and the helium carrier gas can be heated by nuclear reactor 102 and then received by mixture input 312. The effectiveness of the transfer of the radioisotopes from the reactor core to the helium gas can be improved by bubbling the gas through the liquid molten-salt fuel (sparge) and/or increasing the surface area of the fuel by spray nozzles or by evaporation panels. At the end of fractional distillation column 310 (the top as illustrated in FIG. 3) the helium gas has been purified by the fractional distillation process and exits through gas output 314.

Condenser(s) 316 (including 316-1, 316-2, . . . 316-N; N≥1) are each configured and positioned to collect at least one radioisotope of the one or more radioisotopes to be produced using fractional distillation column 310 at isotope output(s) 318 (including 318-1, 318-2, . . . 318-N; N≥1). In this document, a “radioisotope” is an atom having excess nuclear energy, and is also known as radioactive isotope, radionuclide, or radioactive nuclide). Examples of radioisotopes that can be produced using the present system can include (corresponding boiling points in parentheses) protium (20.4 K), deuterium (23.7 K), tritium (25.0 K), xenon-133 (165.1 K), iodine-131 (457.6 K), and/or cesium (944 K). In one embodiment, fractional distillation column 310 produces one or more radioisotopes including at least tritium, which is a radioisotope of hydrogen and also known as hydrogen-3. The symbol for tritium includes T or ³H. In one embodiment, the temperatures of the mixture at mixture input 312 is about 750 K (which can be higher, for example above 1,200 K, depending on design and materials of the relevant reactor structures), and the temperature of the helium gas at gas output 314 is about 20 K (or any temperature above the condensation temperature of helium, which is about 4.2 K and pressure dependent, and below the temperature needed to remove hygrogen). Residue of the fractional distillation process, if any, exits through residue output 320.

In one embodiment, fraction distillation column 310 collects tritium and other valuable radioisotopes from fission products generated by GEM*STAR. Mixture input 312 can receive a mixture containing the helium that flows through the GEM*STAR reactor and picks up the volatile fission products and other volatile radioisotopes produced by neutrons and gammas acting on components of the molten carrier salt. Fractional distillation is applied to the received mixture to produce the one or more radioisotopes. Radioisotopes that have no commercial interest can be stored in appropriate underground containers to decay or be transported to nuclear waste repositories. Some of the valuable radioisotopes can form molecules with boiling points higher than the GEM*STAR operating temperature. These would not make it into the helium flow unless the chemistry of the molten salt were modified such that any desired radioisotope would preferentially form a molecule with a lower boiling point. In the GEM*STAR production of radioisotopes, unlike the example of a usual fractional distillation of crude oil, the effect of gravity is negligible and therefore the orientation of fraction distillation column 310 is not important. For example, FIG. 3 can represent either an elevation or a plan view.

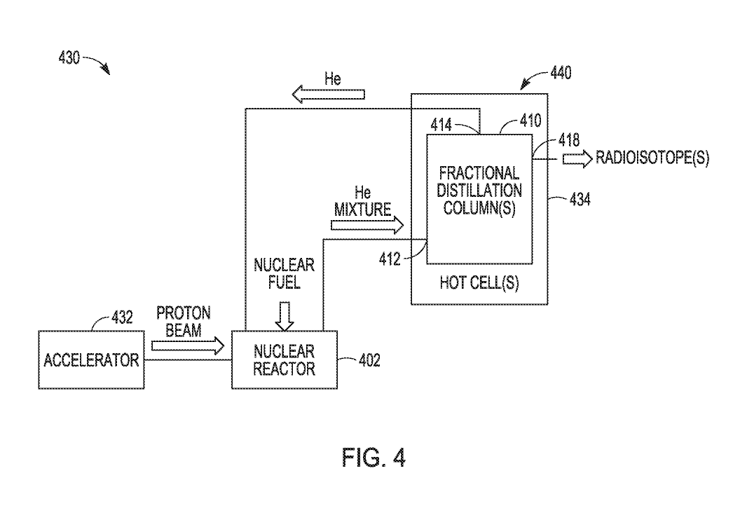

FIG. 4 illustrates an embodiment of a system 430 including a nuclear reactor 402 and a fraction distillation system 440 for collecting radioisotopes from fission products generated by nuclear reactor 402. Fractional distillation system 440 can include one or more distillation columns 410 housed in one or more hot cells 434. Fractional distillation column(s) 410 can each include a fractional distillation column such as fractional distillation column 310 as discussed above. Because of the high levels of radioactivity of the volatile fission products, fractional distillation column(s) 410 are housed in hot cell(s) 434, where remote handling equipment can be used to safely separate and package the radioisotopes to be shipped to appropriate facilities. The volume of the gas passing through fractional distillation column(s) 410 is reduced by the ratio of temperatures or about a factor of 50 from start to finish. The requirements for a refrigeration system to cool fractional distillation column(s) 410 may depend on details of the column design and simulations. However, the value of the radioisotopes is likely so much more than the value of the electricity required that one may consider the electrical operating cost to run the facility as essentially a free byproduct.

Nuclear reactor 402 can include nuclear reactor 102 as discussed in this document (e.g., GEM*STAR) and is driven by an accelerator 432. Accelerator 432 can be a superconducting radio frequency (SRF) accelerator and can emit a proton beam to be received by nuclear reactor 402. Nuclear reactor 402 receives helium (He) and nuclear fuel. The nuclear fuel includes fissile material, which includes one or more substances capable of sustaining a nuclear fission chain reaction. By definition, fissile material can sustain a chain reaction with neutrons of any energy. The predominant neutron energy may be typified by either slow neutrons (i.e., a thermal system) or fast neutrons. Fissile material can be used to fuel thermal-neutron reactors, fast-neutron reactors and nuclear explosives. It has been demonstrated by simulations that an accelerator-driven GEM*STAR burns weapons-grade fissile materials more effectively than burning them in conventional reactors. A mixture of helium and fission products (He MIXTURE) is produced by nuclear reactor 402 and fed into one or more inputs 412 of fractional distillation column(s) 410. Fractional distillation column(s) 410 include one or more gas outputs 414 though which helium (He) exits. This cold helium exiting fractional distillation column(s) 410 can be returned to nuclear reactor 502 by passing next to fractional distillation column(s) 410 where heat exchangers can reduce the load of the external refrigeration system that maintains the column temperature gradient. Accelerator 432 can have a multi-stage refrigeration system to supply the SRF with 2 K cooling. That system can be expanded to provide the cooling for fractional distillation column(s) 410. Similarly, the use of fissile materials that are otherwise unwanted such as surplus plutonium may imply that the reactor fuel is free or even another income producing feature of the process. One or more radioisotopes are produced at one or more isotope outputs 418.

For a GEM*STAR producing tritium at the rate of 2.4 kg/year, the rate of tritium accumulation is about a quarter of a gram per hour. At the same time, there will be 22.5 g/hour of fission products produced, where a fraction will be volatile enough to be carried off by the helium flow. This is likely a large fraction because ²³⁹Pu fission implies an average fission product atomic weight of 120 and the boiling point of ¹³⁴Ce is 75 degrees less than the GEM*STAR operating temperature.

Some non-limiting examples (Examples 1-20) of the present subject matter are provided as follows:

In Example 1, a system for producing and collecting tritium may include a fractional distillation column. The fractional distillation column may be configured to receive a mixture including helium gas and to produce one or more radioisotopes by separating the one or more radioisotopes from the mixture using fractional distillation. The fractional distillation column may include one or more condensers each configured and positioned to collect a radioisotope of the one or more radioisotopes. The one or more condensers may include a condenser configured and positioned to collect the tritium.

In Example 2, the subject matter of Example 1 may optionally be configured such that the mixture include one or more nuclear fission products carried by the helium gas.

In Example 3, the subject matter of Example 2 may optionally be configured to further include a molten-salt nuclear reactor configured for generating electric power while producing the mixture as the one or more nuclear fission products.

In Example 4, the subject matter of Example 3 may optionally be configured to further include a superconducting radio frequency accelerator coupled to the nuclear reactor and configured to drive the nuclear reactor.

In Example 5, the subject matter of any one or any combination of Examples 3 and 4 may optionally be configured such that the nuclear reactor is configured to heat the mixture to a specified temperature to allow for the fractional distillation.

In Example 6, the subject matter of Example 5 may optionally be configured such that the nuclear reactor is configured to heat the mixture to about 750 K.

In Example 7, the subject matter of any one or any combination of Examples 3 to 6 may optionally be configured such that the fractional distillation column is configured to purify the helium gas as a result of the fractional distillation and to output the purified helium gas, and the nuclear reactor is configured to receive the purified helium gas.

In Example 8, the subject matter of any one or any combination of Examples 1 to 7 may optionally be configured to further include a hot cell housing the fractional distillation column.

In Example 9, a method for producing and collecting tritium is provided. The method may include receiving a mixture including helium gas and producing one or more radioisotopes by separating the one or more radioisotopes from the mixture using fractional distillation. The one or more radioisotopes may include the tritium.

In Example 10, the subject matter as found in Example 9 may optionally further include producing the mixture using a molten-salt nuclear reactor configured for generating electric power. The mixture includes one or more fission products produced by the nuclear reactor.

In Example 11, the subject matter as found in Example 10 may optionally further include driving the nuclear reactor using a superconducting radio frequency accelerator.

In Example 12, the subject matter as found in Example 11 may optionally further include using a single refrigeration system to provide for cooling of the superconducting radio frequency accelerator and cooling of a fractional distillation column in which the fractional distillation is performed

In Example 13, the subject matter as found in any one or any combination of Examples 9 to 12 may optionally further include passing helium through the nuclear reactor such that the mixture includes the helium gas carrying the one or more fission products, producing purified helium gas from the mixture using the fractional distillation, and returning the purified helium gas to the nuclear reactor.

In Example 14, the subject matter of returning the purified helium gas to the nuclear reactor as found in Example 13 may optionally include passing the purified helium gas through a refrigeration system that maintains a temperature gradient required for the fractional distillation.

In Example 15, the subject matter as found in any one or any combination of Examples 10 to 14 may optionally further include heating the mixture using the nuclear reactor to a temperature specified for the fractional distillation.

In Example 16, the subject matter of heating the mixture as found in Example 15 may optionally further include heating the mixture to about 750 K.

In Example 17, a system for producing and collecting tritium may include means for receiving a mixture including helium gas and producing one or more radioisotopes including the tritium by separating the one or more radioisotopes from the mixture using fractional distillation and means for producing the mixture.

In Example 18, the subject matter of Example 17 may optionally be configured such that the means for producing the mixture includes means for conducting a nuclear reaction producing the mixture including one or more fission products carried by the helium gas.

In Example 19, the subject matter of Example 18 may optionally be configured such that the means for conducting the nuclear reaction includes an accelerator-driven molten-salt nuclear reactor.

In Example 20, the subject matter of any one or any combination of Examples 18 and 19 may optionally be configured to further include means for purifying the helium gas in the mixture for feeding to the means for conducting the nuclear reaction.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A system for producing and collecting tritium, comprising:
a fractional distillation column configured to receive a mixture including helium gas and to produce one or more radioisotopes by separating the one or more radioisotopes from the mixture using fractional distillation, the fractional distillation column including one or more condensers each configured and positioned to collect a radioisotope of the one or more radioisotopes, the one or more condensers including a condenser configured and positioned to collect the tritium.

2. The system of claim 1, wherein the mixture comprises one or more nuclear fission products carried by the helium gas.

3. The system of claim 2, further comprising a molten-salt nuclear reactor configured for generating electric power while producing the mixture as the one or more nuclear fission products.

4. The system of claim 3, further comprising a superconducting radio frequency accelerator coupled to the nuclear reactor and configured to drive the nuclear reactor.

5. The system of claim 4, wherein the nuclear reactor is configured to heat the mixture to a specified temperature to allow for the fractional distillation.

6. The system of claim 5, wherein the nuclear reactor is configured to heat the mixture to about 750 K.

7. The system of claim 5, further comprising a hot cell housing the fractional distillation column.

8. The system of claim 2, wherein the fractional distillation column is configured to purify the helium gas as a result of the fractional distillation and to output the purified helium gas, and the nuclear reactor is configured to receive the purified helium gas.

9. A method for producing and collecting tritium, comprising:
receiving a mixture including helium gas; and
producing one or more radioisotopes by separating the one or more radioisotopes from the mixture using fractional distillation, the one or more radioisotopes including the tritium.

10. The method of claim 9, further comprising producing the mixture using a molten-salt nuclear reactor configured for generating electric power, the mixture including one or more fission products produced by the nuclear reactor.

11. The method of claim 10, further comprising driving the nuclear reactor using a superconducting radio frequency accelerator.

12. The method of claim 11, further comprising using a single refrigeration system to provide for cooling of the superconducting radio frequency accelerator and cooling of a fractional distillation column in which the fractional distillation is performed

13. The method of claim 10, further comprising:
passing helium through the nuclear reactor such that the mixture includes the helium gas carrying the one or more fission products;
producing purified helium gas from the mixture using the fractional distillation; and
returning the purified helium gas to the nuclear reactor.

14. The method of claim 13, wherein returning the purified helium gas to the nuclear reactor comprises passing the purified helium gas through a refrigeration system that maintains a temperature gradient required for the fractional distillation.

15. The method of claim 10, further comprising heating the mixture using the nuclear reactor to a temperature specified for the fractional distillation.

16. The method of claim 15, wherein heating the mixture comprises heating the mixture to about 750 K.

17. A system for producing and collecting tritium, comprising:
means for receiving a mixture including helium gas and producing one or more radioisotopes including the tritium by separating the one or more radioisotopes from the mixture using fractional distillation; and
means for producing the mixture.

18. The system of claim 17, wherein the means for producing the mixture comprises means for conducting a nuclear reaction producing the mixture including one or more fission products carried by the helium gas.

19. The system of claim 18, wherein the means for conducting the nuclear reaction comprises an accelerator-driven molten-salt nuclear reactor.

20. The system of claim 19, further comprising means for purifying the helium gas in the mixture for feeding to the means for conducting the nuclear reaction.
